(19) United States
(12) Patent Application Publication
(10) Pub. No.: US 2007/0127612 A1
(43) Pub. Date: Jun. 7, 2007

(54) Apparatus and method for retiming data using phase-interpolated clock signal

(76) Inventors: Seung Woo Lee, Seoul (KR); Bhum Cheol Lee, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/633,802

(22) Filed: Dec. 5, 2006

(30) Foreign Application Priority Data
Dec. 5, 2005 (KR) 10-2005-0117659

(51) Int. Cl. H04L 7/00; H04L 7/02

(52) U.S. Cl. 375/355; 375/360; 375/371

(57) ABSTRACT

A data recovering apparatus and method using an interpolated clock signal are provided. The data recovering apparatus comprises a first phase alignment unit extracting from multi-phase clock signals a first clock having an edge most closely corresponding to the center of each bit of input data, a second phase alignment unit extracting from the multi-phase clock signals a second clock having an edge most closely corresponding to the center of each bit of the inverted form of the input data, an interpolated-clock signal generator generating an interpolated rising edge having a phase placed between the phases of rising edges of the first and second clocks, generating an interpolated falling edge having a phase placed between the phases of falling edges of the first and second clocks and generating a phase-interpolated clock signal having the interpolated rising edge and the interpolated falling edge when there is difference between the phases of the rising edges or the falling edges of the first and second clocks, and a data recovering unit retiming the input data based on the phase-interpolated clock signal so as to recover the input data.

### CROSS-REFERENCE TO RELATED PATENT APPLICATION

This application claims the benefit of Korean Patent Application No. 10-2005-0117659, filed on Dec. 5, 2005, in the Korean Intellectual Property Office, the disclosure of which is incorporated herein in its entirety by reference.

### BACKGROUND OF THE INVENTION

1. Field of the Invention

The present invention relates to an apparatus and method for recovering input data including a jitter component using multi-phase clock signals and retiming the input data based on phase-interpolated composite clock signals.

2. Description of the Related Art

A data recovering apparatus in a multi-link system extracts a correct data value from data including a jitter component, which is input through a link, and retimes the data value based on a bit clock signal having a phase, suitable for a variation in the phase of the data.

An analog phase synchronization circuit, using one of a plurality of conventional data retiming techniques, can easily extract a clock signal having a frequency synchronized with input data. However, the analog phase synchronization circuit needs a preamble signal prior to the input data because it takes a relatively long time to synchronize the frequency of the clock signal with the frequency of the input data. Furthermore, the analog phase synchronization circuit has a large area and circuit design is complicated because it includes a voltage-controlled oscillator and a loop filter, which are analog circuits. Thus, it is difficult to use the analog phase synchronization circuit in a multi-link system.

A data retiming technique using two oscillators operates the two oscillators in response to a transition state of input data, combines the output clock signals of the oscillators using a logic OR gate and retimes the input data based on the combined clock signal. Although this technique has a simple configuration, a frequency deviation is generated between the two oscillators which makes it difficult to obtain a clock signal synchronized with the frequency of the input data in multiple links. Furthermore, a jitter component of the input data is transmitted to a bit clock pulse, and thus a buffer having a high operating speed is required.

FIG. 1 illustrates a conventional data recovering apparatus. The conventional data recovering apparatus compares input data to multi-phase clock signals, selects at least one clock signal from the multi-phase clock signals, which have clock edges closely corresponding to the centers of bits of the input data and combines the selected clock signal with the multi-phase clock signals to generate composite clock signals. Then, the conventional data recovering apparatus retimes the input data based on the composite clock signals.

The conventional data recovering apparatus distorts the duty cycle of the clock signal selected from the multi-phase clock signals because a jitter component included in the input data is transferred to the clock signal. Furthermore, the conventional data recovering apparatus cannot react to a high-frequency jitter component in real time because the selected clock signal is aligned and combined with the multi-phase clock signals after several cycles from a transition point of the input data. This can generate an error when the input data is recovered.

### SUMMARY OF THE INVENTION

The present invention provides an apparatus and method for reducing a distortion of a composite clock signal so as to guarantee a uniform timing margin and stable operation at all times.

The present invention also provides an apparatus and method for recovering and retiming input data including a high-frequency jitter component by selecting a clock signal at an inverted transition time following a transition time of the input data and interpolating the phase of the clock signal so as to reduce the time it takes to react to the jitter component of the input data.

According to an aspect of the present invention, there is provided a data recovering apparatus comprising: a first phase alignment unit extracting a first clock having an edge most closely corresponding to the center of each bit of input data from multi-phase clock signals; a second phase alignment unit extracting a second clock having an edge most closely corresponding to the center of each bit of the inverted form of the input data from the multi-phase clock signals; an interpolated-clock generator generating an interpolated rising edge having a phase placed between the phases of rising edges of the first and second clocks, generating an interpolated falling edge having a phase placed between the phases of falling edges of the first and second clocks and generating a phase-interpolated clock signal having the interpolated rising edge and the interpolated falling edge when the phases of the rising edges or the falling edges of the first and second clocks do not correspond to each other; and a data recovering unit retiming the input data based on the phase-interpolated clock signal in order to recover the input data.

The first phase alignment unit may compare the phases of rising edges of the input data to each of the phases of the multi-phase clock signals and extract the first clock having an edge most closely corresponding to the center of each bit of the input data.

The first phase alignment unit may comprise a first phase controller receiving the input data as a clock input of a first flip-flop, receiving each of the multi-phase clock signals as a data input of the first flip-flop, receiving the output of the first flip-flop as a data input of a second flip-flop and receiving the inverted form of the input data as a clock input of the second flip-flop.

According to another aspect of the present invention, there is provided a data recovering method comprising: extracting from multi-phase clock signals a first clock having an edge most closely corresponding to the center of each bit of input data; extracting from the multi-phase clock signals a second clock having an edge most closely corresponding to the center of each bit of the inverted form of the input data; generating an interpolated rising edge having a phase falling between the phases of rising edges of the first and second clocks when there is difference between the phases of the rising edges or the falling edges of the first and second clocks; generating an interpolated falling edge having a phase placed between the phases of falling edges of the first and second clocks when there is difference between the phases of the rising edges or the falling edges of the first and second clocks; generating a phase-interpolated clock signal having the interpolated rising edge and the interpolated falling edge; and retiming the input data based on the phase-interpolated clock signal to order to recover the input data.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional data recovering apparatus;

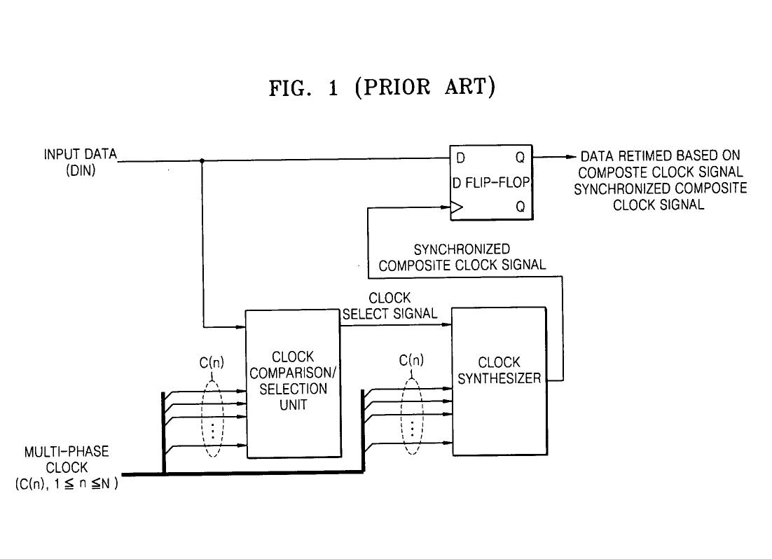

FIG. 2 illustrates a data recovering apparatus according to an embodiment of the present invention;

FIG. 3 illustrates a configuration of a data recovering apparatus according to another embodiment of the present invention;

FIG. 4 is a circuit diagram of a phase alignment unit of the data recovering apparatus according to an embodiment of the present invention;

FIG. 5 is a circuit diagram of a phase alignment unit of the data recovering apparatus according to another embodiment of the present invention;

FIG. 6 is a timing diagram of input data and clock signals used in the data recovering apparatus illustrated in FIGS. 3 and 4; and

FIG. 7 is a timing diagram of input data and clock signals used in the data recovering apparatus illustrated in FIGS. 3 and 5.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

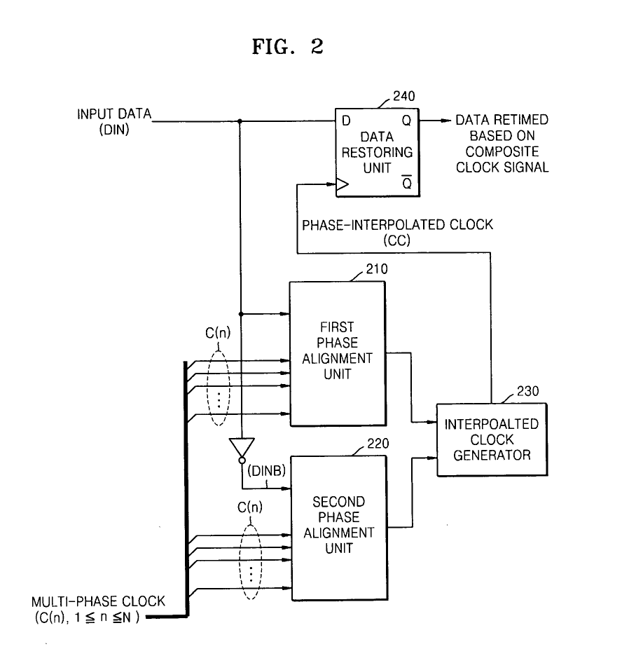

FIG. 2 illustrates a data recovering apparatus according to an embodiment of the present invention. The data recovering apparatus includes a first phase alignment unit 210, a second phase alignment unit 220, an interpolated clock signal generator 230 and a data recovering unit 240.

The first phase alignment unit 210 compares the phase of input data DIN to the phases of multi-phase clock signals C[n] (1≦n≦N) and extracts from the multi-phase clock signals C[n] a first clock signal having a falling edge most closely corresponding to the center of each bit of the input data DIN.

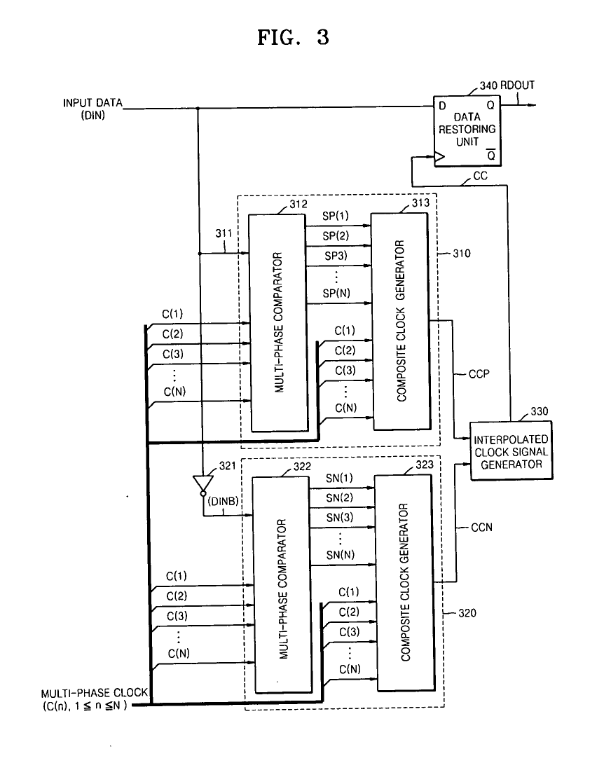

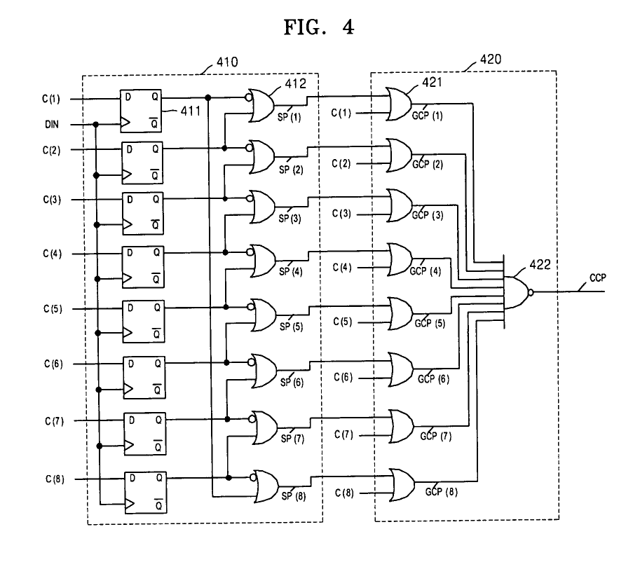

The second phase alignment unit 220 compares the phase of the inverted form of the input data DIN to the phases of the multi-phase clock signals C[n] and extracts from the multi-phase clock signals C[n] a second clock signal having a falling edge most closely corresponding to the center of each bit of the inverted input data. The first and second phase alignment units 210 and 220 will be explained below in more detail with reference to FIGS. 3 and 4.

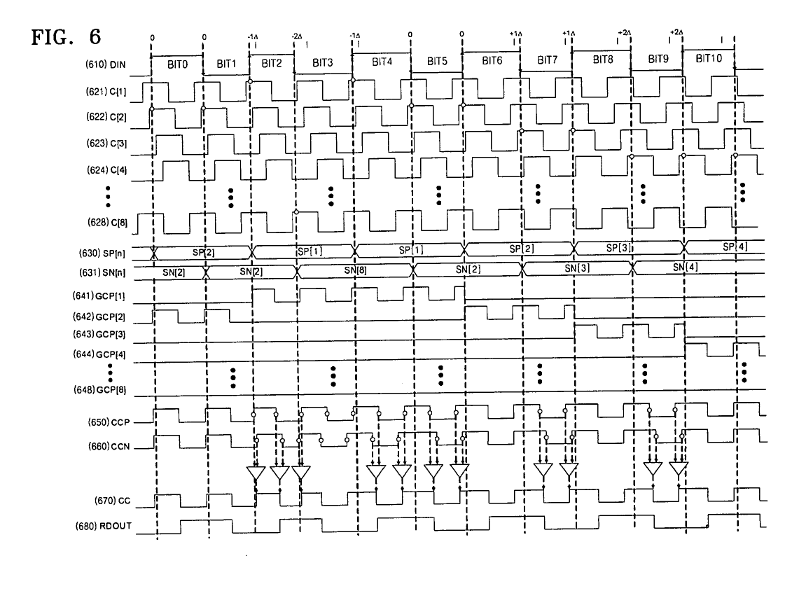

The interpolated-clock generator 230 combines the first and second clock signals in order to generate a phase-interpolated clock signal CC having a phase placed between the phase of the first clock signal and the phase of the second clock signal when there is difference between rising edges or falling edges of the first and second clock signals. This will be explained below in more detail with reference to FIGS. 3 and 6.

The data restoring unit 240 retimes the input data DIN with the phase-interpolated clock signal generated by the interpolated clock generator 230 in order to recover the input data.

FIG. 3 illustrates a configuration of the data recovering apparatus according to an embodiment of the present invention. Referring to FIG. 3, the first phase alignment unit 310 (corresponding to the first phase alignment unit 210 illustrated in FIG. 2) includes a multi-phase comparator 312 and a composite clock generator 313. The multi-phase comparator 312 compares the input data (DIN) 311 to the multi-phase clock signals C[1], C[2], through to C[N] (C[n], 1≦n≦N), respectively, and outputs resultant signals SP[1], SP[2], through to SP[N] (SP[n], 1≦n≦N).

The composite clock generator 313 combines the resultant signals SP[1], SP[2], through to SP[N] and the multiple phase clock signals C[1], C[2], through to C[N] using logic circuits to generate a clock signal CCP having an edge most closely corresponding to the center of each bit of the input data DIN.

The second phase alignment unit 320 (corresponding to the second phase alignment unit 220 illustrated in FIG. 2) includes a multi-phase comparator 322 and a composite clock generator 323. The multi-phase comparator 322 compares the inverted input data (DINB) 321 to the multiple phase clock signals C[1], C[2], through to C[N] (C[n],1≦n≦N), respectively, and outputs resultant signals SN[1], SN[2], through to SN[N] (SN[n], 1≦n≦N).

The composite clock generator 323 combines the resultant signals SN[1], SN[2], through to SN[N] and the multiple phase clock signals C[1], C[2], through to C[N] using logic circuits to generate a clock signal CCN having an edge most closely corresponding to the center of each bit of the input data DIN.

The interpolated-clock generator 330 (corresponding to the interpolated-clock generator 230 illustrated in FIG. 2) generates an interpolated rising edge, which has a phase placed between the phase of a rising edge of the clock signal CCP generated by the first phase alignment unit 310 and the phase of a rising edge of the clock signal CCN generated by the second phase alignment unit 320, and an interpolated falling edge, which has a phase placed between the phase of a falling edge of the clock signal CCP and the phase of a falling edge of the clock signal CCN, when there is difference between the phase of the rising edge or the falling edge of the clock signal CCP and the phase of the rising edge or the falling edge of the clock signal CCN. Then, the interpolated-clock generator 330 generates the phase-interpolated clock signal CC based on the interpolated rising edge and the interpolated falling edge.

The data recovering unit 340 retimes the input data DIN with the phase-interpolated clock signal CC generated by the interpolated-clock generator 330 in order to recover the input data DIN.

FIG. 4 is a circuit diagram of the phase alignment unit 310 and 320 of the data recovering apparatus according to an embodiment of the present invention. The phase alignment unit includes the multi-phase comparator 410 (corresponding to the multi-phase comparators 312 and 322) and the composite clock generator 420 (corresponding to the composite clock generators 313 and 323).

When the number N of the multi-phase clock signals is 8, the multi-phase comparator 410 includes eight positive-edge triggered D flip-flops 411 and eight 2-input OR gates 412. The D flip-flops 411 respectively receive the multi-phase clock signals C[1] through C[8] as data inputs and receive the input data DIN or the inverted input data DINB as clock inputs. The first through seventh OR gates 412 respectively receive the inverted values of the outputs of the first through seventh D flip-flops 411 and the outputs of the second through eighth D flip-flops 411 and the eighth OR gate 412 receives the inverted value of the output of the eighth D flip-flop 411 and the output of the first D flip-flop 411.

Each of the D flip-flops 411 samples the binary value of C[n] at rising edges of the input data DIN and outputs the sampled value. Each of the OR gates 412 receives the inverted value of the output of the D flip-flop 411 connected thereto and the output of the next D flip-flop and outputs SP[n] having a value ‘0’ only when C[n] is ‘1’ and C[n+1] is ‘0’ at the rising edges of the input data DIN, thereby representing that a falling edge of C[n] most closely corresponds to the center of each bit of the input data.

The composite clock generator 420 includes eight 2-input OR gates 421 respectively receiving the outputs SP[1] through SP[8] of the OR gates 412 and the multi-phase clock signals C[1] through C[8], and an 8-input NOR gate 422 receiving the outputs of the eight 2-input OR gates 421.

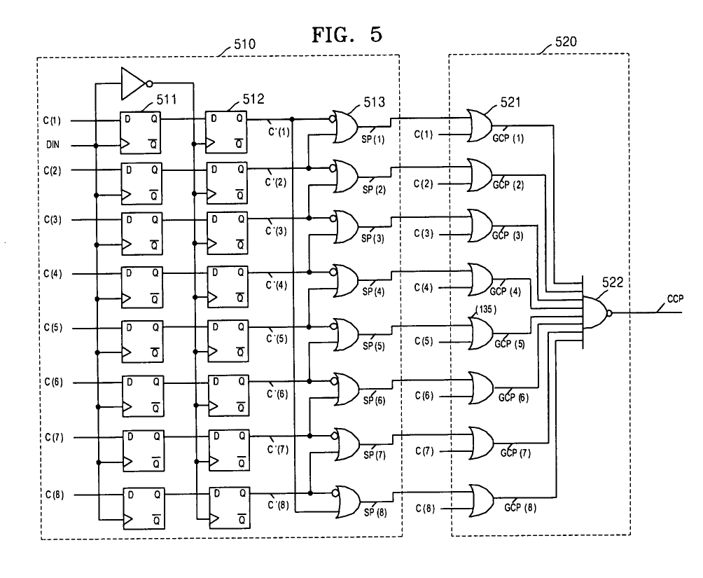

FIG. 5 is a circuit diagram of the phase alignment unit of the data recovering apparatus according to another embodiment of the present invention. The phase alignment unit illustrated in FIG. 5 further includes D flip-flops 512 in addition to the components of the phase alignment unit illustrated in FIG. 4 in order to prevent a condition of meta-stability occurred when the data input to the D flip-flops 411 of the phase alignment unit illustrated in FIG. 4 has an insufficient setup time and hold time. The D flip-flops 512 respectively receive the outputs of the D flip-flops 511 as data inputs and receive the inverted form of the input data as clock inputs. The functions of the components other than the D flip-flops 512 are identical or similar to those of the phase alignment unit illustrated in FIG. 4.

FIG. 6 is a timing diagram of the input data and clock signals including the interpolated clock signal used in the data recovering apparatus illustrated in FIGS. 3 and 4. It is assumed that the input data DIN has a jitter component as follows.

| | DIN | | | | | | | | | |
|---|---|---|---|---|---|---|---|---|---|---|
| | Bit | Bit | Bit | Bit | Bit | Bit | Bit | Bit | Bit | Bit |
| | 0 | 1 | 2 | 3 | 4 | 5 | 6 | 7 | 8 | 9 |
| Jitter | 0 | −1D | −1D | +1D | +1D | 0 | −1D | 0 | 0 | 0 |

Here, D corresponds to 1/N of one cycle of a data bit (N=8).

Bits of the input data DIN have jitter components at a reference transition point. The binary value of C[n] and the output of the multi-phase comparator, SP(n), are changed at a rising edge or a falling edge of the input data DIN as the rising edge or the falling edge is varied in a positive (+) or a negative (−) direction from the reference transition point.

When the number N of the multi-phase clock signals is 8, the clock signal C[n] has the same frequency as a data bit rate and a delay between C[n] and C[n+1] corresponds to ⅛ of one cycle of a data bit.

As illustrated in FIG. 6, the binary values of C[1] through C[8] at the rising edge of bit 0 of the input data DIN are 1, 1, 0, 0, 0, 0, 1, and 1, respectively, and thus the outputs SP[1] through SP[8] of the multi-phase comparator 312 (illustrated in FIG. 3) become 1, 0, 1, 1, 1, 1, 1, and 1, respectively. The multi-phase comparator selects an output SP[n] having a value ‘0’, which shows that C[n] corresponding to the selected SP[n] has an edge most closely corresponding to the center of each bit of the input data. In the case of FIG. 6, SP[2] is selected at the rising edge of bit 0.

The binary values of C[n] at the falling edge of bit 0 of the input data DIN are 1, 1, 0, 0, 0, 0, 1, and 1, respectively, and thus the outputs SN[n] of the multi-phase comparator 322 (illustrated in FIG. 3) become 1, 0, 1, 1, 1, 1, 1, and 1, respectively. The multi-phase comparator 322 selects an output SP[n] having a value ‘0’, which shows that C[n] corresponding to the selected SP[n] has an edge most closely corresponding to the center of each bit of the input data. In the case of FIG. 6, SP[2] is selected at the falling edge of bit 0.

The 2-input OR gates 421 of the composite clock generator 420 illustrated in FIG. 4 receive the multi-phase clock signals C[n] and the outputs SP[n] of the multi-phase clock comparator 410, output C[n] when SP[n] is ‘0’, and output GCP[n] having a value ‘1’ when SP[n] is ‘1’, respectively. That is, C[n] is selected when SP[n] is ‘0’, and thus GCP[n] becomes equal to C[n].

GCP[n] corresponds to the result of the logic OR operation of SP[n] and C[n]. GCP[2] has the same clock signal as C[2] in a period from the rising edge of bit 0 of the input data DIN to the rising edge of bit 2 of the input data DIN and GCP[1] has the same clock signal as C[1] in a period from the rising edge of bit 2 of the input data DIN to the rising edge of bit 6 of the input data DIN. Accordingly, a clock signal having an edge most closely corresponding to the center of each bit of the input data is continuously selected for every rising edge of the input data DIN.

The 8-input NOR gate 422 of the composite clock generator 420 illustrated in FIG. 4 receives one of the signals GCP[n] as the same value as C[n] and the other signals GCP[n] as ‘1’ and performs a logic NOR operation on them in order to generate the composite clock signals CCP and CCN having edges most closely corresponding to the center of each bit of the input data DIN.

The interpolated clock generator 330 illustrated in FIG. 3 receives the composite clock signal CCP generated by the first phase alignment unit 310 and the composite clock signal CCN generated by the second phase alignment unit 320 and outputs the phase-interpolated clock signal CC having a phase placed between the phases of the two clock signals CCP and CCN.

Specifically, the clock signal C[1] is selected at the rising edge of bit 2 of the input data DIN so that SP[1] becomes ‘0’ and GCP[1] has the same phase as C[1] in a period from the rising edge of bit 2 of the input data DIN to the rising edge of bit 6 of the input data DIN, as illustrated in FIG. 6. Furthermore, the clock signal C[2] is selected at the falling edge of bit 0 of the input data DIN so that SN[2] becomes ‘0’ and GCN[2] has the same phase as C[2] in a period from the falling edge of bit 0 of the input data DIN to the falling edge of bit 2 of the input data DIN.

Accordingly, the two composite clock signals CCP and CCN have different phases in a period from the rising edge of bit 2 of the input data DIN to the rising edge of bit 6 of the input data DIN and the interpolated clock generator outputs the phase-interpolated clock signal CC.

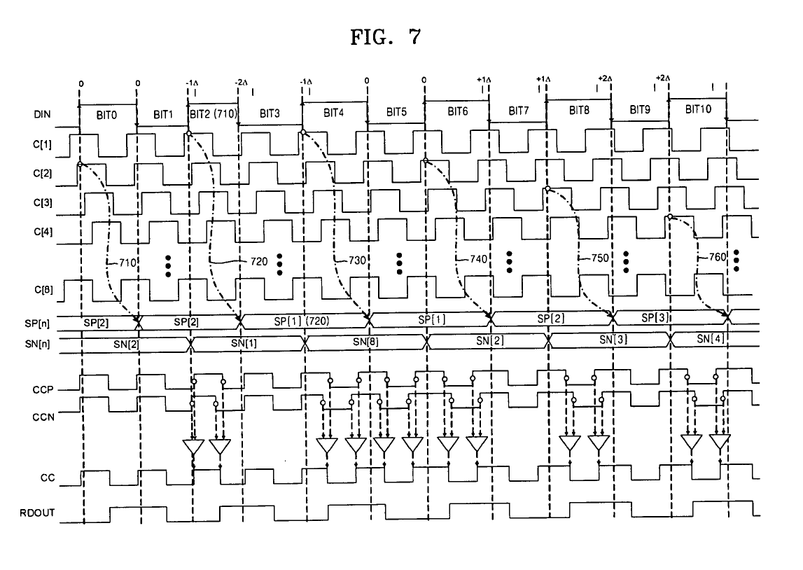

FIG. 7 is a timing diagram of the input data and clock signals including the phase-interpolated clock signal used in the data recovering apparatus illustrated in FIGS. 3 and 5. It is assumed that the input data DIN has the same jitter component as that of the input data DIN illustrated in FIG. 6.

Referring to FIGS. 5 and 7, the clock signals C[1] through C[8] respectively become 1, 1, 0, 0, 0, 0, 1, and 1 at the rising edge of bit 0 of the input data DIN and the outputs C′[1] through C′[8] of the flip-flops 512 respectively become 1, 1, 0, 0, 0, 0, 1, and 1 at the falling edge of bit 0 of the input data DIN. In this case, the outputs SP[1] through SP[8] of the multi-phase comparator 510 become 1, 0, 1, 1, 1, 1, 1, and 1. As described above with respect to FIG. 6, the waveform of SP[n] becomes identical to SP[2]. The values of the multi-phase clock signals C[n] at a rising edge of the input data DIN are output as C′[n] at a falling edge of the input data DIN and output as SP[n] through the OR gates 513. That is, a clock signal selected at a rising edge of the input data DIN is transferred and appears at a falling edge of the input data DIN.

As illustrated in FIG. 7, the composite clock generator 520 receives the outputs SP[n] of the multi-phase comparator 510 and multi-phase clock signals C[n] and generates the composite clock signal CCP. The interpolated-clock generator 330 (illustrated in FIG. 3) receives the composite clock signal CCP generated by the first phase alignment unit and the composite clock signal CCN generated by the second phase alignment unit in order to generate the phase-interpolated clock signal CC.

The clock signal C[1] selected at the rising edge of bit 2 710 of the input data DIN is transferred and appears as SP[1] 720 at the falling edge of bit 2 of the input data DIN. That is, even when a clock signal having an edge closely corresponding to the center of each bit of the input data DIN is selected, the clock signal is delayed by a period from the rising edge to the falling edge of each bit. However, the D flip-flops 512 are added, as illustrated in FIG. 5, to reduce the probability that meta-stability occurs, thereby stabilizing the circuit.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

The present invention can use a phase-interpolated composite clock signal in data recovering and retiming operations in order to reduce the distortion of a duty cycle and easily guarantee a timing margin. Furthermore, the present invention selects an appropriate clock signal at an inverted transition time following a transition time of input data and generates a phase-interpolated bit clock signal so as to reduce a time to react to a jitter component of the input data. Accordingly, it is possible to recover and retime even input data that includes a high-frequency jitter component.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A data recovering apparatus comprising:
a first phase alignment unit extracting a first clock having an edge most closely corresponding to the center of each bit of input data from multi-phase clock signals;
a second phase alignment unit extracting a second clock having an edge most closely corresponding to the center of each bit of the inverted form of the input data from the multi-phase clock signals;
an interpolated-clock signal generator generating an interpolated rising edge having a phase placed between the phases of rising edges of the first and second clocks, generating an interpolated falling edge having a phase placed between the phases of falling edges of the first and second clocks, and generating a phase-interpolated clock signal having the interpolated rising edge and the interpolated falling edge when there is difference between the phases of the rising edges or the falling edges of the first and second; and
a data restoring unit retiming the input data based on the phase-interpolated clock signal in order to recover the input data.

2. The data recovering apparatus of claim 1, wherein the first phase alignment unit compares the phases of rising edges of the input data to each of the phases of the multi-phase clock signals and extracts the first clock having an edge most closely corresponding to the center of each bit of the input data.

3. The data recovering apparatus of claim 1, wherein the second phase alignment unit compares the phases of falling edges of the input data to each of the phases of the multi-phase clock signals and extracts the second clock having an edge most closely corresponding to the center of each bit of the inverted form of the input data.

4. The data recovering apparatus of claim 1, wherein the first phase alignment unit comprises a first phase controller receiving the input data as a clock input of a first flip-flop, receiving each of the multi-phase clock signals as a data input of the first flip-flop, receiving the output of the first flip-flop as a data input of a second flip-flop and receiving the inverted form of the input data as a clock input of the second flip-flop.

5. The data recovering apparatus of claim 1, wherein the second phase alignment unit comprises a second phase controller receiving the inverted form of the input data as a clock input of a first flip-flop, receiving each of the multi-phase clock signals as a data input of the first flip-flop, receiving the output of the first flip-flop as a data input of a second flip-flop and receiving the input data as a clock input of the second flip-flop.

6. A data recovering method comprising:
extracting from multi-phase clock signals a first clock having an edge most closely corresponding to the center of each bit of input data;
extracting from the multi-phase clock signals a second clock having an edge most closely corresponding to the center of each bit of the inverted form of the input data;
generating an interpolated rising edge having a phase placed between the phases of rising edges of the first and second clocks when there is difference between the phases of the rising edges or the falling edges of the first and second clocks; generating an interpolated falling edge having a phase placed between the phases of falling edges of the first and second clocks when there is difference between the phases of the rising edges or the falling edges of the first and second clocks;
generating a phase-interpolated clock signal having the interpolated rising edge and the interpolated falling edge; and
retiming the input data based on the phase-interpolated clock signal in order to recover the input data.

7. The data recovering method of claim 6, wherein the extracting of the first clock compares the phases of rising edges of the input data to each of the phases of the multi-phase clock signals and extracts the first clock having an edge most closely corresponding to the center of each bit of the input data.

8. The data recovering method of claim 6, wherein the extracting of the second clock compares the phases of falling edges of the input data to each of the phases of the multi-phase clock signals and extracts the second clock having an edge most closely corresponding to the center of each bit of the inverted form of the input data.
